(19) United States
(12) Patent Application Publication
(10) Pub. No.: US 2014/0248474 A1
(43) Pub. Date: Sep. 4, 2014

(54) METHOD FOR APPLYING A SUPERABSORBENT POLYMER ONTO A FIBROUS SHEET MATERIAL AND A DOUBLE-OR MULTIPLY FIBROUS MATERIAL CONTAINING SUPERABSORBENT MATERIAL

(71) Applicant: Anders Strålin, Torslanda (SE)

(72) Inventor: Anders Strålin, Torslanda (SE)

(73) Assignee: SCA HYGIENE PRODUCTS AB, Göteborg (SE)

(21) Appl. No.: 14/124,954

(22) PCT Filed: Jun. 8, 2012
(86) PCT No.: PCT/SE2012/050626

§ 371 Date: Mar. 31, 2014

Related U.S. Application Data
(60) Provisional application No. 61/495,398, filed on Jun. 10, 2011.

(51) Int. Cl. A47K 10/16; B32B 38/00

(52) U.S. Cl. CPC A47K 10/16; B32B 38/145
USPC 428/196; 427/288; 156/277; 101/129; 101/483

(57) ABSTRACT

A method is provided for applying a superabsorbent polymer to a fibrous sheet material. The fibrous sheet material may be a nonwoven material or a tissue paper. The method includes applying a crosslinkable polymeric dispersion or solution onto the fibrous sheet material by printing technique and in a separate step applying a crosslinking agent onto the fibrous sheet material by printing technique, wherein said crosslinking agent accomplishes crosslinking of the crosslinkable polymer to form a superabsorbent material. A tissue or nonwoven product-includes at least two plies that are bonded together, wherein a crosslinked superabsorbent material is applied in a printed pattern between the plies, said tissue or nonwoven product having a DIN54540 Water Absorption between 15 and 100 g/g.

### TECHNICAL FIELD

The present disclosure refers to a method for applying a superabsorbent polymer to a fibrous sheet material. The fibrous sheet material may be a nonwoven material or a tissue paper. The disclosure further refers to a double- or multiply tissue paper or nonwoven having superabsorbent material applied between at least two plies.

### BACKGROUND

Superabsorbent polymers are used to enhance the absorbent capacity in absorbent articles like diapers, incontinence care articles, sanitary napkins etc. The superabsorbent polymers are mostly used in particulate form and are mixed with a fibrous matrix or applied as layers between fibrous layers. It would also be desired to enhance the absorbent capacity of fibrous sheet material, such as nonwoven materials and tissue paper, by means of superabsorbent polymers. There has however been a problem to find suitable techniques for applying superabsorbent polymers to such materials.

US 2008/0032014 discloses a superabsorbent printable composition which can be applied to sheetlike materials for food packaging, for packaging moisture-sensitive goods etc. The composition comprises superabsorbent polymeric particles, an organic water-insoluble binder and an organic solvent. The composition is applied to the substrate by printing, especially by gravure printing.

EP-A1 0357474 discloses a fibrous web having enhanced capacity for water absorption produced by impregnating an absorbent fabric with a crosslinkable polymer and subsequently heating the treated fabric to effect crosslinking of the polymer to form an absorbent polymer.

U.S. Pat. No. 6,043,311 discloses a printable formulation of a superabsorbent polymer usable for example for nonwovens. The formulation is applied in a two-component package consisting of a precrosslinked superabsorbent and a reactive crosslinking agent and are mixed in situ shortly before application to the substrate.

US 2008/0128101 discloses a method of introducing a superabsorbent polymer and a crosslinking agent to a paper web. The superabsorbent polymer is added as solution and the preferred method of adding the polymer solution is by spraying.

There is still a need for methods for applying a superabsorbent material to a sheetlike fibrous material, such as a nonwoven or tissue paper.

### SUMMARY

It is accordingly an object of the present disclosure to provide an effective method for applying and attaching a superabsorbent material to a sheetlike fibrous material in order to enhance the absorbent capacity of the sheetlike fibrous material. According to the present disclosure the method comprises: applying a crosslinkable polymeric dispersion in a non-solvent carrier onto the fibrous sheet material by printing technique and in a separate step applying a crosslinking agent onto the fibrous sheet material by printing technique, wherein said crosslinking agent accomplishes crosslinking of said crosslinkable polymer to form a superabsorbent material, and wherein a neutralizing agent is added together with the crosslinking agent or in a separate step.

The fibrous sheet material may be a nonwoven material or a tissue paper.

The crosslinkable polymer may be a copolymer of an ethylenically unsaturated carboxylic monomer and an ethylenically unsaturated monomer

The ethylenically unsaturated carboxylic monomer may be chosen from: acrylic acid, methacrylic acid, crotonic acid, maleic acid, itaconic acid and fumaric acid.

The ethylenically unsaturated monomer may be chosen from: methyl methacrylates, ethyl methacrylates, methyl acrylates, ethyl acrylates and butyl acrylates

The crosslinking agent may be a multivalent ion or a compound containing a multivalent ion. The multivalent ion may be a cation.

The concentration of said crosslinkable polymeric dispersion measured as the amount of dry substance may be in the range 10 to 50 weight % based on the total weight of the dispersion.

The non-solvent carrier in said crosslinkable polymeric dispersion may be water.

The pH of said crosslinkable polymeric dispersion may be between 2 and 4.

The viscosity of said crosslinkable polymeric dispersion may be between 20 and 200 mPas (Apparent viscosity, ISO 2555, Brookfield RVT, 23° C., Spindle 1, 100 rpm). The crosslinkable polymeric dispersion, the crosslinking agent and the neutralizing agent may be printed in patterns that coincide with each other.

Printing of the crosslinkable polymeric dispersion, the crosslinking agent and the neutralizing agent may be performed in register while the sheet material resides on a common central impression roll.

The printing technique used may be flexographic printing or rotary screen printing.

The printing pattern used may be a discontinuous pattern comprising a plurality of printing sites which are disconnected from each other.

The crosslinkable polymeric dispersion, the crosslinking agent and the neutralizing agent may be applied onto a first side of a first ply of fibrous sheet material and said first ply may be laminated with a second ply of fibrous sheet material with said first side of the first ply facing the second ply.

The superabsorbent material may act as a binder to bind the first and second plies together.

The first and second plies may be bonded together in a pattern of water insoluble binder leaving unbonded areas therebetween.

The pattern of water insoluble binder may be provided by thermoplastic bonds and/or a water insoluble adhesive.

The present disclosure further refers to a tissue or nonwoven product comprising at least two plies that are bonded together, wherein a crosslinked superabsorbent material is applied in a printed pattern between at least two plies, said superabsorbent material being bonded to at least one ply, said tissue or nonwoven product having a DIN54540 Water Absorption between 15 and 100 g/g.

### BRIEF DESCRIPTION OF THE DRAWINGS

FIG. 1 discloses schematically a flexographic printing process for applying a superabsorbent material to a sheet-like material.

### DETAILED DESCRIPTION OF PREFERRED EMBODIMENTS

The fibrous sheet materials used in the process of the present disclosure are mainly tissue paper or nonwoven materials.

A tissue paper is defined as a soft absorbent paper having a basis weight below 65 g/m² and typically between 10 and 50 g/m². Its density is typically below 0.60 g/cm³, preferably below 0.30 g/cm³ and more preferably between 0.08 and 0.20 g/cm³.

The fibers contained in the tissue paper are mainly pulp fibers from chemical pulp, mechanical pulp, thermo mechanical pulp, chemo mechanical pulp and/or chemo thermo mechanical pulp (CTMP). The fibers may also be recycled fibers. The tissue paper may also contain other types of fibers enhancing e.g. strength, absorption or softness of the paper. These fibers may be made from regenerated cellulose or synthetic material such as polyolefins, polyesters, polyamides etc.

A nonwoven material is defined as a bonded fibrous or filamentous web product, in which the fibers or filaments are oriented in a random manner or with a certain degree of orientation. The fibers can be natural, e.g. wood pulp of the same type as used in tissue paper, cotton, jute, hamp, linen, sisal etc., or manmade, e.g. rayon, lyocell, polyolefins, polyesters etc. The fibers in a nonwoven material are bonded together by the use of different bonding techniques, such as heat-bonding, hydroentangling, binding agents etc.

Examples of nonwoven materials are hydroentangled (spunlace) webs, spunbond webs, meltblown webs, airlaid webs, bonded carded webs.

Absorbency is a desired property for tissue paper and for many nonowoven materials, especially for wipes. Tissue paper and nonwoven materials have a limited absorbent capacity, which could be enhanced by the incorporation of superabsorbent materials. Superabsorbent polymers are water-swellable, water-insoluble materials capable of absorbing at least about 20 times its weight of water and aqueous liquids of different kind. Organic materials suitable for use as a superabsorbent material can include natural materials such as polysaccharides, polypeptides and the like, as well as synthetic materials such as synthetic hydrogel polymers. Such hydrogel polymers include, for example, polyacrylic acid and its salts, polymethacrylic acid and its salts, polyethylacrylic acid and its salts, polybutylacrylic acids and its salts, polymethacrylate, polyethylacrylate, polybutylacrylate, polymethylmethacrylate, partly hydrolyzed acrylamide, poly-AMPS (2-acrylamideo-2-methylpropane sulfonic acid) and copolymers thereof.

Other examples of hydrogel polymers include polyacrylamides, polyvinyl alcohol, polyvinyl pyridines, hydrolyzed acrylonitrile grafted starch, acrylic acid grafted starch, and isobutylene maleic anhydride copolymers and mixtures thereof. The hydrogel polymers are crosslinked to render the material substantially water insoluble.

The present disclosure relates to a method by which a superabsorbent polymer is effectively applied and attached to a fibrous sheet material. The method is further adapted to be run at high speeds.

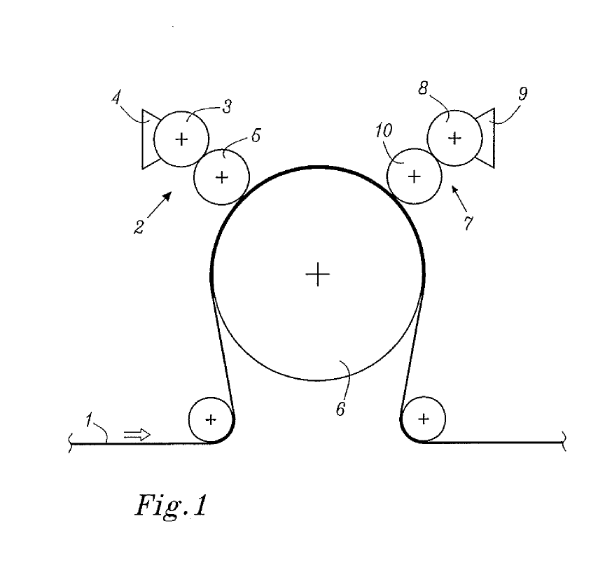

As illustrated in FIG. 1 a sheet material 1, such as a tissue paper or a nonwoven material, is forwarded to a first printing station 2, which in this embodiment is a flexographic printing station. The first printing station comprises an anilox roll 3 which passes through a doctorblade chamber 4 holding a crosslinkable polymeric dispersion. The anilox roll 3 transfers a controlled amount of the dispersion to a printing roll 5 having a flexographic printing plate or cliché mounted thereon. The dispersion is transferred to the sheet material 1 by means of the printing roll 5 in a nip between the printing roll 5 and a central impression roll 6.

In a second printing station 7, which in this embodiment is also a flexographic printing station, a crosslinking agent is transferred from an anilox roll 8 passing through a doctorblade chamber 9 holding a crosslinking agent and a neutralizing agent. The anilox roll 8 transfers a controlled amount of the crosslinking agent and neutralizing agent to a printing roll 10 having a flexographic printing plate or cliché mounted thereon. The crosslinking agent and the neutralizing agent are transferred to the sheet material 1 by means of the printing roll 10 in a nip between the printing roll 10 and the central impression roll 6.

The printing patterns on the printing rolls 5 and 10 are the same and the printing rolls 5 and 10 are synchronized so that the patterns will coincide on the sheet material, i.e. so that the crosslinking agent is printed onto the pattern of crosslinkable polymeric dispersion or solution. Synchronization is readily obtained due to the central impression roll 6 which is common for the two printing stations 2 and 7, thus enabling the printing stations to work in register.

Examples of crosslinkable polymers which may be used are copolymers of an ethylenically unsaturated carboxylic monomer and an ethylenically unsaturated monomer. Examples of ethylenically unsaturated carboxylic monomers are acrylic acid, methacrylic acid, crotonic acid, maleic acid, itaconic acid and fumaric acid. Examples of copolymerizable ethylenically unsaturated monomers are methyl methacrylates, ethyl methacylates, methyl acrylates, ethyl acrylates and butyl acrylates.

One example is an acrylic acid copolymer. This polymer is used in the form of an aqueous dispersion. The concentration of the dispersion measured as the amount dry substance may be in the range 10-50 weight % based on the total weight of the dispersion. The non-solvent carrier may be water. The pH of such dispersion may be in the range 2-4. The dispersion will at such a low pH have a low viscosity readily adapted for printing.

To allow crosslinking and the formation of a superabsorbent polymer, a high molecular weight of the printed acrylic acid copolymer is preferred. If the polymer is water soluble, a high molecular weight results in a high viscosity. This makes it difficult to apply the polymer by printing (or spraying) technologies at solids content above 10%.

In a polymer dispersion the polymer chains are unfolded and not dissolved. The viscosity of the polymer dispersion is thus relatively low and mainly dependent on the number of particles and particle size. By printing a polymer dispersion a high molecular weight polymer can be combined with a low viscosity and high solids content. The neutralization and dissolution of the dispersed polymer chains is made by applying the chemistry for neutralization by another printing step.

One example of such a crosslinkable polymer is an aqueous anionic dispersion of a copolymer of ethyl acrylate and acrylic acid sold under the trade name Sterocoll®.

By addition of a neutralizing agent, for example an aqueous NaOH-solution the pH will rise to about 6-7 and the carboxylic acid sodium salt is formed. This makes the polymer particles soluble in water and a polymer solution is formed. At the same time the viscosity strongly increases due to unfolding of the polymer molecules.

When a polymer dispersion such as Sterocoll® is neutralized it goes into solution. The viscosity of acrylic acid co-polymer dispersions used for printing at 10-50% solids content, at pH 2-4 should be in the range 10-200 mPas. For Sterocoll® HT the viscosity at 40% solids content, at pH 2.8 is 50 mPas (Apparent viscosity, ISO 2555, Brookfield RVT, 23° C., Spindle 1, 100 rpm).

The viscosity of acrylic acid copolymers diluted to 3% and neutralised to a pH of 6-7 should be in the range 500-5000 mPas. For Sterocoll®HT diluted to 3%, the Brookfield viscosity increase from 13 to 3400 mPas as the pH increase from 3.4 to 6.5.

By introducing a crosslinking agent in the form of multivalent cations like calcium, aluminum, zirconium, magnesium, iron and/or zinc ions or compounds containing such multivalent cations a ionically crosslinked superabsorbent polymer is obtained with a high water holding capacity. One example of a crosslinking agent is an ammonium zirconium carbonate sold under the trade name Bacote 20®.

The neutralizing agent, e.g. NaOH, and the crosslinking agent, e.g. multivalent cations or compounds containing multivalent cations, may be added in combination in the same printing station or in separate printing stations. In the latter case three printing stations are provided.

The three components: crosslinkable polymer, neutralizing agent and crosslinking agent, may be added to the sheet material in any order, e.g. the neutralizing agent and crosslinking agent may in an alternative embodiment be printed on the sheet material before the crosslinkable polymer.

In a further alternative embodiment two or more layers of superabsorbent material are printed on the sheet material in order to increase the amount of superabsorbent material. For example a dispersion of crosslinkable polymer is added in a first and a third printing station and a neutralizing agent and crosslinking agent are added in a second and a fourth printing station. All printing stations may have the same central impression roll.

After the sheet material has passed the printing stations it is dried and converted to the final products in conventional manner. A heating step may be provided after the last printing station in order to enhance the crosslinking reaction.

The amount of superabsorbent added onto the sheet material may be in the range 2-30 gsm as calculated on dry substance and with respect to those areas of the sheet material having superabsorbent material printed thereon. When calculated on the total surface of the sheet material the amount of superabsorbent material may be in the range 1-15 gsm.

The printing pattern is preferably a discontinuous printing pattern comprising a plurality of printing sites that are disconnected from each other. With such a printing pattern the stiffness of the sheet material will be effected as little as possible.

The absorption capacity of a tissue paper or nonwoven material treated with a superabsorbent material according to the present disclosure will significantly increase its absorption capacity, A normal tissue paper has a DIN Water Absorption in the range 4 to 8 g/g and a nonwoven material useful as a wipe have an absorption in the same range, When applying a superabsorbent material to the tissue paper or nonwoven material the absorption capacity can be doubled or more, depending on the amount that is applied and of the absorption capacity of the superabsorbent material per se.

By using printing technique the superabsorbent material will be effectively bonded to the sheet material. Although flexographic printing has been referred to above, it is understood that other printing techniques may be used, for example rotary screen printing.

In one embodiment an additional sheet material, which may be of the same or of a different type, is laminated to the side of the sheet material onto which the superabsorbent forming components have been printed and before complete drying thereof, wherein the superabsorbent material may acts as a binder binding together the two plies of sheet material.

The first and second plies may further be bonded together in a pattern of a water insoluble binder, such as a water insoluble adhesive or thermoplastic bonds, leaving unbonded areas therebetween. These unbonded areas will allow the superabsorbent material to swell upon wetting, The water insoluble binder will keep the plies bonded together also in a wetted condition and thus prevent delamination. The pattern of water insoluble binder may be accomplished by a hotmelt glue and/or by thermoplastic fibers mixed into the fibrous sheet materials and heatbonded in a bonding pattern. Another example is to use a water insoluble adhesive, such as a polymer dispersion glue, e.g. a latex. Combinations of thermoplastic bonds and water insoluble adhesive may also be used.

A tissue or nonwoven product comprising at least two plies that are bonded together and holding a printed pattern of crosslinked superabsorbent material between them according to the present disclosure may have a DIN 54540 Absorption between 15 and 100 g/g, preferably between 15 and 30 g/g, depending on the amount and type of superabsorbent material applied.

### EXAMPLE

TABLE 1

| | | | | b) Neutralisation and | |
|---|---|---|---|---|---|
| | | a) Polymer dispersion | | crosslinking solution | |
| | | Polymer | Solid | 10% | 10% |
| Sam- | Polymer | Dispersion | polymer | NaOH | Bacote 20 ® |
| ple | Dispersion | Weight [g] | weight [g] | [g] | [g] |
| 1 | Sterocoll ® HT | 1.0 | 0.4 | 0.5 | 0.5 |
| 2 | Sterocoll ® HT | 1.0 | 0.4 | 0.5 | 0.75 |
| 3 | Sterocoll ® D | 1.6 | 0.4 | 0.5 | 0.5 |
| 4 | Sterocoll ® D | 1.6 | 0.4 | 0.5 | 0.75 |
| 5 | Sterocoll ® FS | 1.0 | 0.4 | 0.5 | 0.5 |
| 6 | Sterocoll ® FS | 1.0 | 0.4 | 0.5 | 0.75 |

TABLE 2

| | | | | Applied | | | DIN54540 |
|---|---|---|---|---|---|---|---|
| | | | Dry paper | SAP | Wet paper weight | DIN54540 | Absorption |
| | | | weight after | coating | after DIN54540 | water | from SAP |
| | Polymer dispersion | Dry paper | SAPappllcation | weight | water absorption | absorption | polymer |
| Sample | and crosslinking | weight [g] | [g] | [g/m²] | [g] | [g/g] | part [g/g] |
| 1 | Sterocoll ® HT with | 0.540 | 0.658 | 5.9 | 12.5 | 19.0 | 70 |
| | 0.5 g Bacote 20 ® | | | | | | |
| 2 | Sterocoll ® HT with | 0.538 | 0.668 | 6.5 | 17.4 | 26.1 | 102 |
| | 0.75 g Bacote 20 | | | | | | |
| 3 | Sterocoll ® D with | 0.548 | 0.68 | 6.6 | 11.3 | 16.7 | 54 |
| | 0.5 g Bacote 20 ® | | | | | | |
| 4 | Sterocoll ® D with | 0.539 | 0.668 | 6.5 | 12.5 | 18.7 | 65 |
| | 0.75 g Bacote 20 ® | | | | | | |
| 5 | Sterocoll ® FS with | 0.541 | 0.666 | 6.3 | 11.8 | 17.7 | 61 |
| | 0.5 g Bacote 20 ® | | | | | | |
| 6 | Sterocoll ® FS with | 0.535 | 0.662 | 6.4 | 10.3 | 15.6 | 49 |
| | 0.75 g Bacote 20 ® | | | | | | |
| 7 | Reference without | 0.542 | 0.542 | 0 | 4.05 | 7.5 | |
| | superabsorbent | | | | | | |
| | polymer | | | | | | |
| 8 | Reference without | 0.544 | 0.544 | 0 | 4.29 | 7.9 | |
| | superabsorbent | | | | | | |
| | polymer | | | | | | |

1. A method for applying a superabsorbent polymer to a fibrous sheet material, the method comprising applying a crosslinkable polymeric dispersion in a non-solvent carrier onto the fibrous sheet material by printing and in a separate step applying a crosslinking agent onto the fibrous sheet material by printing, wherein said crosslinking agent accomplishes crosslinking of said crosslinkable polymer to form a superabsorbent material, and wherein a neutralizing agent is added together with the crosslinking agent or in a separate step.

2. The method as claimed in claim 1, wherein said fibrous sheet material is a nonwoven material or a tissue paper.

3. The method as claimed in claim 1, wherein said crosslinkable polymer is a copolymer of an ethylenically unsaturated carboxylic monomer and an ethylenically unsaturated monomer.

4. The method as claimed in claim 3, wherein said ethylenically unsaturated carboxylic monomer is chosen from: acrylic acid, methacrylic acid, crotonic acid, maleic acid, itaconic acid and fumaric acid.

5. The method as claimed in claim 3, wherein said ethylenically unsaturated monomer is chosen from: methyl methacrylates, ethyl methacrylates, methyl acrylates, ethyl acrylates and butyl acrylates.

6. The method as claimed in claim 1, wherein the crosslinking agent is a multivalent ion or a compound containing a multivalent ion.

7. The method as claimed in claim 6, wherein the multivalent ion is a cation.

8. The method as claimed in claim 1, wherein a concentration of said crosslinkable polymeric dispersion measured as the an amount of dry substance is in the range 10 to 50 weight % based on the a total weight of the dispersion.

9. The method as claimed in claim 1, wherein the non-solvent carrier in said crosslinkable polymeric dispersion is water.

10. The method as claimed in claim 8, wherein the pH of said crosslinkable polymeric dispersion is between 2 and 4.

11. The method as claimed in claim 10, wherein the viscosity of said crosslinkable polymeric dispersion is between 20 and 200 mPas.

12. The method as claimed in claim 1, wherein the crosslinkable polymeric dispersion, the crosslinking agent and the neutralizing agent are printed in patterns that coincide with each other.

13. The method as claimed in claim 12, wherein printing of the crosslinkable polymeric dispersion, the crosslinking agent and the neutralizing agent is performed in register while the sheet material resides on a common central impression roll.

14. The method as claimed in claim 1, wherein the printing is flexographic printing or rotary screen printing.

15. The method as claimed in claim 1, wherein the printing is a discontinuous pattern comprising a plurality of printing sites which are disconnected from each other.

16. The method as claimed in claim 1, further comprising applying the crosslinkable polymeric dispersion, the crosslinking agent and the neutralizing agent onto a first side of a first ply of fibrous sheet material, and laminating said first ply with a second ply of fibrous sheet material with said first side of the first ply facing the second ply.

17. The method as claimed in claim 16, wherein the superabsorbent material acts as a binder to bind the first and second plies together.

18. The method as claimed in claim 16, wherein the first and second plies are bonded together in a pattern of water insoluble binder leaving unbonded areas therebetween.

19. The method as claimed in claim 18, wherein the pattern of water insoluble binder is provided by thermoplastic bonds and/or a water insoluble adhesive.

20. A tissue or nonwoven product comprising at least two plies that are bonded together, wherein a crosslinked superabsorbent material is applied in a printed pattern between the at least two plies, said superabsorbent material being bonded to at least one of the at least two plies, said tissue or nonwoven product having a DIN54540 Water Absorption between 15 and 100 g/g.
